(19) United States
(12) Patent Application Publication
(10) Pub. No.: US 2026/0338033 A1
(43) Pub. Date: Oct. 29, 2026

(54) GAS-PROOF ROLL-UP DOOR, PARTICULARLY OF THE VERTICAL RAPID SLIDING TYPE

(71) Applicant: BMPEUROPE S.r.l., VILLANOVA d’ASTI (AT) (IT)

(72) Inventor: Danilo BENOTTO, Montá (CN) (IT)

(21) Appl. No.: 19/661,450

(22) Filed: Apr. 28, 2026

(30) Foreign Application Priority Data
Apr. 28, 2025 (IT) 102025000009408

(51) Int. Cl. E06B 9/64; E06B 9/58; E06B 9/70

(52) U.S. Cl. CPC E06B 9/64; E06B 9/581; E06B 9/70

(57) ABSTRACT

A fast vertically sliding roll-up door includes a flexible curtain is connected to a crosspiece and has a transverse edge connected with a motorized winding roller parallel to the crosspiece, and a cylindrical member freely rotatable and arranged on the curtain to cause movement of the curtain by gravity, and a pair of arcuate support elements associated with a base of said uprights for the cylindrical member ends. An adhesion material is being associated with the crosspiece and curtain, uprights, arcuate support elements, and lower plate for sealingly closing the opening by the curtain.

### CROSS REFERENCE TO RELATED APPLICATION

The present application claims benefit to Italian Patent Application Serial No. 102025000009408, filed Apr. 28, 2025, the contents of which are incorporated herein by reference.

### FIELD OF THE INVENTION

The present invention relates in general to doors for industrial use, particularly to vertically sliding doors having the function of opening or closing, by means of a flexible curtain, an opening formed in a wall and delimited by a portal structure.

### SUMMARY OF THE INVENTION

More specifically, the invention relates to a door of the rapid vertically sliding type, in which the opening and closing of the door take place with a relatively high speed, of the order of a few seconds.

The purpose of the invention is to propose a door of the above-mentioned type which allows said opening to be closed in a highly effective manner, avoiding gas leakages between the two environments upstream and downstream of the roll-up door when the latter is in the closed condition, so as to obtain a hermetic closure of the door.

This purpose is achieved by the invention due to the fact that the door comprises:
a flexible curtain intended to assume an open position or a closed position with respect to a wall opening delimited by a portal structure including an upper crosspiece and a lower plate arranged substantially at the threshold of the portal structure, and a pair of parallel uprights, the curtain having an outer face and an inner face and having a first transverse edge connected with the upper crosspiece and a second transverse edge connected to the surface of a motorized winding roller arranged in proximity to the crosspiece and parallel thereto, as well as a pair of opposite longitudinal edges;
a cylindrical member arranged in a freely rotatable manner on the inner face of the curtain between said crosspiece and the winding roller to cause the movement of the curtain by gravity toward said lower plate, namely toward the closed configuration of said opening
a pair of arcuate support elements associated with the base of said uprights for the sealed support of the ends of the cylindrical member when the latter is in contact with said lower plate in the closed configuration of the door; and
adhesion means associated with the upper crosspiece of the portal structure and with said first transverse edge of the curtain, as well as with the uprights, the arcuate support elements, the lower plate and the curtain, for sealingly closing said opening by means of the flexible curtain.

By virtue of these characteristics, the door of the invention allows the opening associated with the portal structure to be effectively closed with a seal.

According to a preferred characteristic of the invention, the adhesion means are magnetic adhesion means which comprise a pair of strips of magnetic material transversely fixed on the outer face of the curtain, respectively in proximity to its first transverse edge and to a median zone thereof which corresponds to the contact zone with said lower plate when the curtain assumes the closed configuration, as well as a pair of flexible strips of magnetic material fixed on the outer side of the curtain in proximity to its longitudinal edges between said two transverse strips, said upper crosspiece, said lower plate, said parallel uprights, and said arcuate support elements being metallic, particularly made of ferromagnetic material.

In this manner, the magnetic strips of the curtain cooperate with the crosspiece of the portal structure, with both uprights, with the lower plate and with the arcuate support elements to cause sealing with respect to gases in the closed configuration of the door.

According to another preferred characteristic of the invention, said cylindrical member is a tubular element.

In this manner, the cylindrical member can perform its function of causing the movement of the curtain by gravity toward the lower plate, while being relatively lightweight.

According to a further preferred characteristic of the invention, each of said arcuate support elements has an upwardly facing concave supporting surface having a radius of curvature substantially equal to the radius of said cylindrical member.

In this manner, it is possible to ensure the sealing of the curtain interposed between the cylindrical member and the arcuate support elements at the base of the uprights of the portal structure.

According to a further preferred characteristic of the invention, a pair of opposed guide rails parallel to said uprights are associated with the portal structure, said guide rails having respective vertical grooves in which a pair of axial pins protruding from the opposite ends of the cylindrical member slidingly engage.

This allows the vertical movement of the cylindrical member with respect to the portal structure to be effectively guided.

According to an additional preferred characteristic of the invention, said first transverse edge of the curtain is connected with the upper crosspiece of the portal structure by means of a horizontal bar for supporting the curtain and an angle profile connected to the upper crosspiece, adjustment means being provided for adjusting the vertical position of the first transverse edge with respect to the upper crosspiece.

This allows the vertical position of one end of the curtain with respect to the portal structure to be adjusted.

### BRIEF DESCRIPTION OF THE DRAWINGS

Further characteristics and advantages of the invention will emerge more clearly from the detailed description that follows, provided purely by way of non-limiting example and referring to the appended drawings in which:

FIG. 1 is a schematic perspective view of a fast vertically sliding roll-up door according to the invention, in its closed condition corresponding to the completely lowered configuration of the roll-up door;

FIG. 2 is a top elevation view of the door of FIG. 1 from the side of arrow II;

FIG. 3 is a rear elevation view of half of the curtain of the door of FIG. 1 from the side of arrow III;

FIG. 4 is a top elevation view of the curtain of the door of FIG. 3 sectioned along line IV-IV of said figure;

FIG. 5 is a side elevation view sectioned longitudinally which illustrates the door of the invention in its closed configuration and in a configuration close to the closed configuration; and

FIG. 6 is a schematic perspective view on an enlarged scale illustrating an arcuate support element arranged at the base of a respective upright of the portal structure of the door according to the invention.

### DETAILED DESCRIPTION OF THE INVENTION

With reference to the drawings, a roll-up door according to the invention is indicated as a whole by the reference numeral 10.

The door 10 is associated with a portal structure 12 arranged at an access opening 14 formed in a separating wall 15 of two environments, one upstream and the other downstream of the opening 14, at least one of which contains an atmosphere different from that of the other, for example having a different gaseous composition.

The opening 14 is laterally delimited by a pair of vertical and parallel metallic uprights 16, by an upper and horizontal metallic crosspiece 18, and by a lower base plane consisting of a flat and horizontal metallic plate 20 arranged at the threshold of the portal structure 12.

The metallic elements defined above are advantageously made of ferromagnetic material. The opening 14 can be closed by means of a roll-up curtain made by a flexible curtain 22 of plastic material such as PVC, polyethylene or polyurethane, or of plastic-coated textile material, usually having a thickness of the order of one millimeter or a few millimeters.

The curtain 22, which extends between the crosspiece 18 and a motorized winding roller 24 arranged in proximity to the crosspiece 18 and parallel thereto, has an outer face 22a and an inner face 22b and has a longitudinal extension slightly greater than twice the height of the opening 14.

In particular, the curtain 22 has a first transverse end edge 22c at the crosspiece 18, a second transverse end edge 22d fixed to the surface of the roller 24, and a pair of opposite longitudinal edges 22e and 22f.

From the transverse edge 22c there extend portions of the curtain 22 which form a plurality of loops 26 the cavity of which is engaged by a horizontal supporting bar 28. The bar 28, in turn, has a plurality of threaded rods 30 protruding perpendicularly, intended to be inserted into corresponding holes 34 of a wing 32a of an angle bar 32 arranged above the crosspiece 18 of the portal structure 12.

In particular, the angle bar 32 is fixed at a housing zone 38 arranged above the crosspiece 18 and in which the winding roller 24 of the curtain 22 is positioned, the axis of the roller 24 being connected with the output shaft of an electric motor 40 usually supported directly by the portal structure 12.

The threaded ends of the rods 30 are engaged, above the wing 32a, by tightening nuts 36 which can be screwed in an adjusted manner to vary the height of the curtain 22, in particular of its first transverse edge 22c, in order to position the latter at a desired height with respect to the portal structure 12.

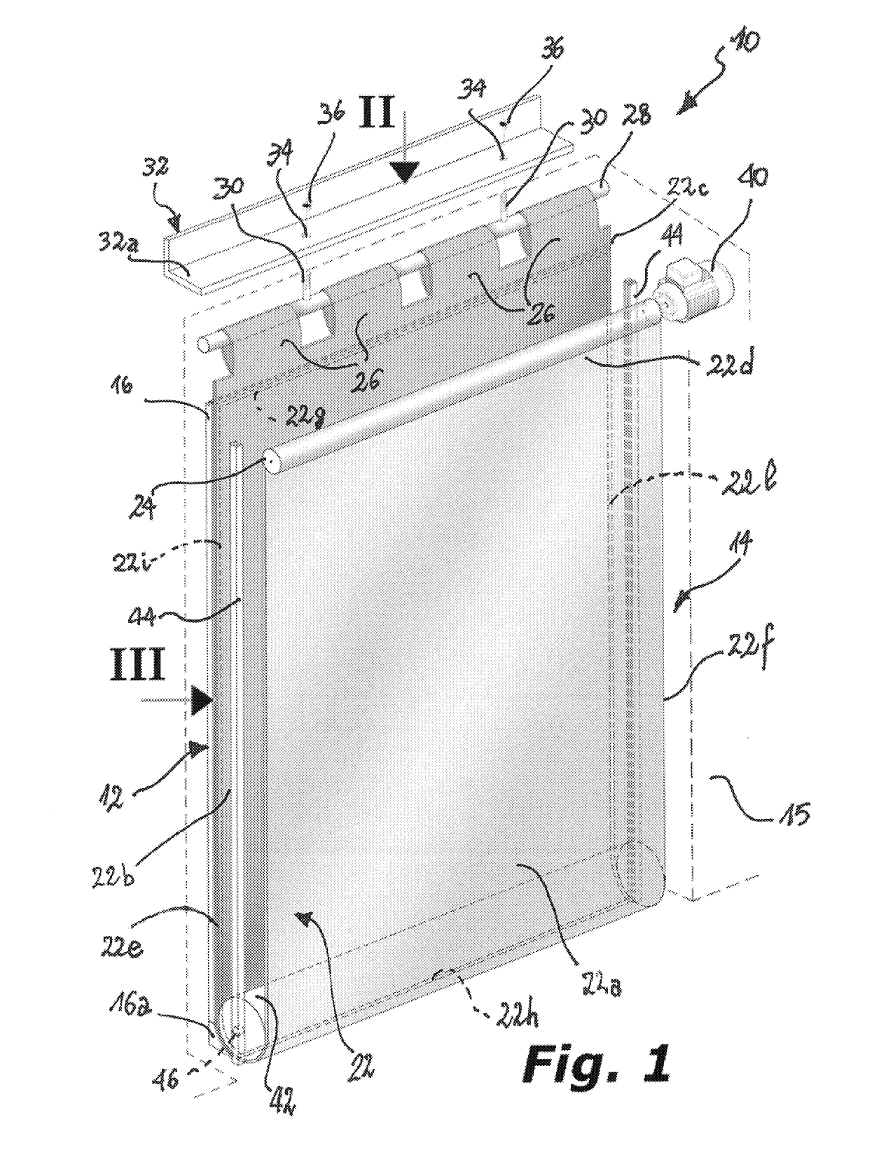

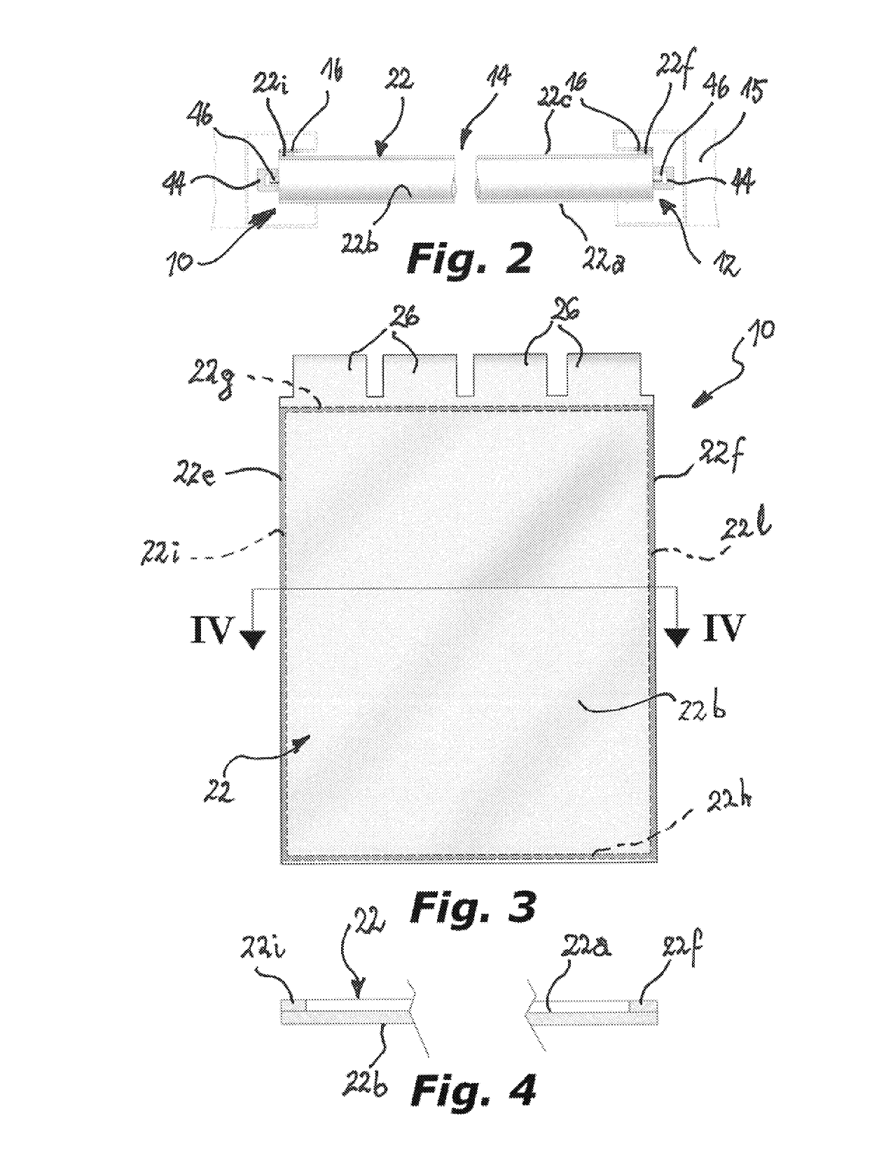

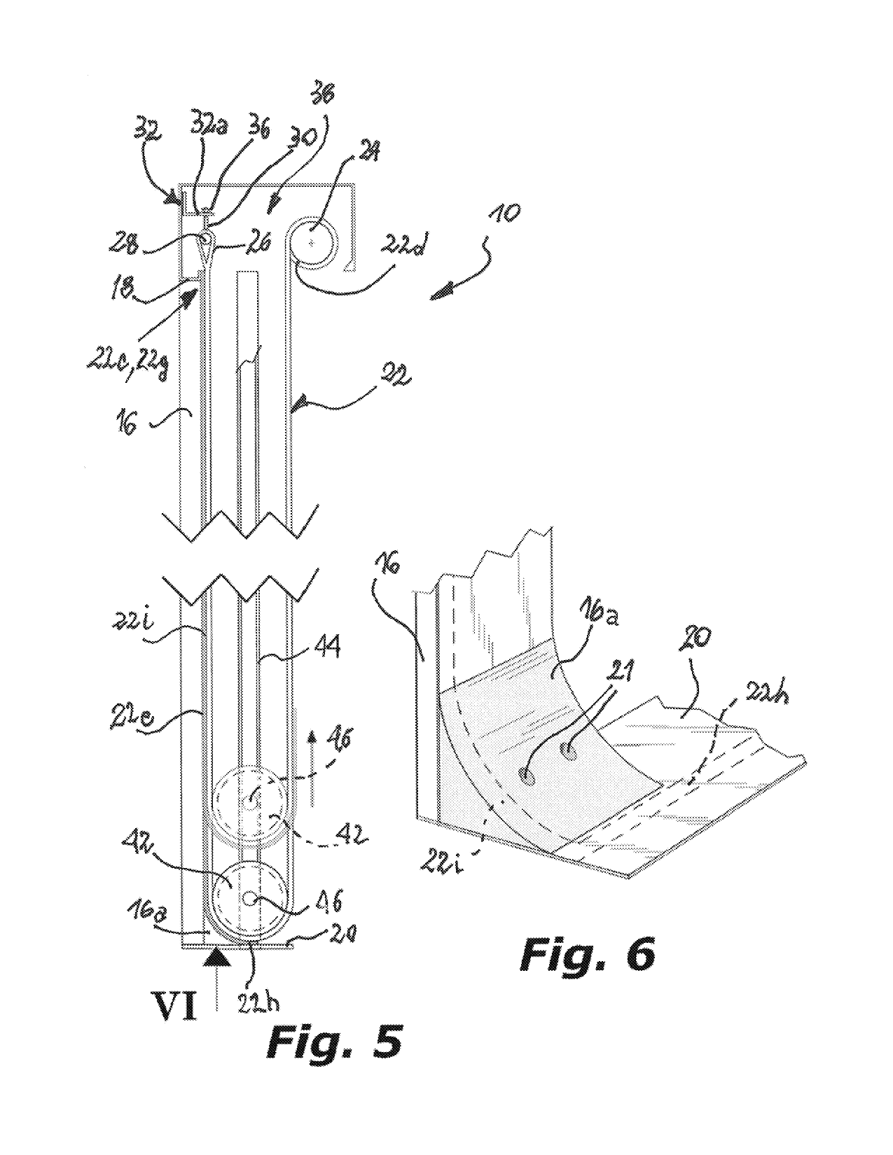

On the inner face 22b of the curtain 22 there is arranged, between the crosspiece 18 and the winding roller 24, in a freely rotatable manner, a cylindrical member 42, for the purpose of weighting the curtain 22 and causing its movement by gravity toward the lower metallic plate 20, when the rotation of the winding roller 24 allows the unwinding of the curtain 22 toward the closed configuration of the door 10 (see FIGS. 1 and 5). Preferably, the cylindrical member 42 has a tubular structure.

Due to the presence of the tubular member 42 and the fact that the curtain 22 has a length extension substantially equal to twice the height of the opening 14, the curtain 22 in the closed configuration of the door 10 assumes a U-shaped configuration in a side view.

The portal structure 12 further comprises a pair of opposed guide rails 44 parallel to the uprights 16, which have respective vertical grooves in which a pair of axial pins 46 protruding from the centers of the opposite ends of the cylindrical member 42 slidingly engage.

Moreover, at the base of the uprights 16 there are arranged respective metallic arcuate support elements 16a for the sealed support of the axial ends of the cylindrical member 42 in the closed configuration of the door 10, when the cylindrical member 42 has reached contact with the lower metallic plate 20.

Each arcuate element 16a, which is advantageously fixed to the lower metallic plate 20 for example by means of screws inserted into suitable cavities 21, has an upwardly facing concave and circular supporting surface, the radius of curvature of which is substantially equal to the radius of the cylindrical member 42, in order to favor its coupling with the lower portion of the curtain 22 which locally assumes a circular profile due to the presence of the cylindrical member 42.

On the outer face 22a of the curtain 22, at its first transverse end edge 22c, a first magnetic strip 22g is fixed for coupling it with the crosspiece 18, while in the median portion of the curtain 22 a second magnetic strip 22h parallel to the strip 22g is fixed, in the zone of the curtain 22 intended to come into contact with the lower metallic plate 20 due to the thrust exerted by the cylindrical member 42 when the curtain 22 is in the closed configuration.

The strips 22g and 22h are respectively intended to adhere magnetically to the crosspiece 18 and to the lower metallic plate 20.

Between the ends of the transverse strips 22g and 22h, thus in proximity to the longitudinal edges 22e and 22f of the curtain 22, there extend on the outer face 22a of the curtain 22 a pair of respective flexible magnetic strips 22i and 22l intended to adhere magnetically to the uprights 16 and to the metallic arcuate support elements 16a of the portal structure 12.

In operation, following the unwinding of the curtain 22 from the motorized roller 24, due to the action of the load constituted by the cylindrical member 42, the curtain 22 lowers to the floor stopping when it reaches contact with the metallic plate 20 and the opposite ends of the cylindrical member 42 are arranged in support on the arcuate elements 16a with the interposition of the curtain 22.

In this configuration, the magnetic strip 22g of the first transverse edge 22c of the curtain 22 is magnetically coupled with the crosspiece 18, the longitudinal magnetic strips 22i and 22l of the curtain 22 adhere to the metallic uprights 16 along their entire height as well as to the two arcuate support elements 16a, while the transverse magnetic strip 22h fixed to the median portion of the curtain 22 adheres to the lower metallic plate 20.

In this manner a flexible roll-up closure is obtained constituted by the curtain 22 whose four edges, both longitudinal and transverse, adhere to the portal structure 12 by means of respective magnetic elements so as to guarantee a hermetic sealing.

What is claimed is:

1. roll-up door, particularly of the vertical rapid sliding type, comprising
a flexible curtain configured to assume an open or closed position with respect to a wall opening delimited by a portal structure that includes an upper crosspiece and a lower plate arranged substantially at the doorsill of the portal structure, and a pair of parallel uprights, the curtain having an outer face and an inner face and having a first transverse edge connected to the upper crosspiece and a second transverse edge connected to the surface of a motorized winding roller arranged close to the crosspiece and parallel to it, as well as a pair of opposite longitudinal edges,
a cylindrical member arranged freely rotatable on the inner face of the curtain between said crosspiece and the winding roller to cause the movement of the curtain by gravity towards said lower plate, that
is towards the closed configuration of said opening,
a pair of curved support members associated with the base of said uprights for the sealed support of the ends of the cylindrical member when the latter is in contact with said lower plate in the closed configuration of the door, and
an adhesion material associated with the upper crosspiece of the portal structure and with said first transverse edge of the curtain, as well as with the uprights, with the curved support members, with the lower plate and with the curtain to seal said opening by the flexible curtain.

2. The roll-up door according to claim 1, wherein the adhesion material comprises a magnetic material which comprise a pair of strips of magnetic material fastened transversely on the outer face of the curtain, respectively in the vicinity of its first transverse edge and of a median zone thereof corresponding to the zone of contact with said lower plate when the curtain assumes the closed configuration, as well as a pair of flexible strips of magnetic material fastened on the outer side of the curtain in the vicinity of its longitudinal edges between the two aforementioned transverse strips, said upper crosspiece, said lower plate, said parallel uprights and said curved support members being metallic, particularly of ferromagnetic material.

3. The roll-up door according to claim 1, wherein said cylindrical member is a tubular element.

4. The roll-up door according to claim 1, wherein each of said curved support members has a concave support surface facing upwards and having a radius of curvature substantially equal to the radius of said cylindrical member.

5. The roll-up door according to claim 1, wherein the curved support members are fixed to said lower plate, preferably by screws.

6. The roll-up door according to claim 1, wherein a pair of opposite guide rails parallel to said uprights are associated with the portal structure, which guide rails have respective vertical grooves in which a pair of axial pins projecting from the opposite ends of the cylindrical member slidably engage.

7. The roll-up door according to claim 1, wherein said first transverse edge of the curtain is connected to the upper crosspiece of the portal structure by a horizontal support bar of the curtain and an angle bar connected to the upper crosspiece, and an adjustment device for the vertical position of the first transverse edge with respect to the upper crosspiece is provided.

8. The roll-up door according to claim 7, wherein said adjustment device comprises a plurality of threaded rods projecting from said support bar for their insertion into holes of a wing of said angle bar and for tightening them by nuts.

9. The roll-up door according to claim 7, wherein said support bar is configured to engage a plurality of loops formed by portions of the curtain extending from said first transverse edge of the curtain.

10. The roll-up door according to claim 2, wherein said cylindrical member is a tubular element.

11. The roll-up door according to claim 2, wherein each of said curved support members has a concave support surface facing upwards and having a radius of curvature substantially equal to the radius of said cylindrical member.

12. The roll-up door according to claim 2, wherein the curved support members are fixed to said lower plate, preferably by screws.

13. The roll-up door according to claim 2, wherein a pair of opposite guide rails parallel to said uprights are associated with the portal structure, which guide rails have respective vertical grooves in which a pair of axial pins projecting from the opposite ends of the cylindrical member slidably engage.

14. The roll-up door according to claim 2, wherein said first transverse edge of the curtain is connected to the upper crosspiece of the portal structure by a horizontal support bar of the curtain and an angle bar connected to the upper crosspiece, and an adjustment device for the vertical position of the first transverse edge with respect to the upper crosspiece is provided.

15. The roll-up door according to claim 14, wherein said adjustment device comprises a plurality of threaded rods projecting from said support bar for their insertion into holes of a wing of said angle bar and for tightening them by nuts.

16. The roll-up door according to claim 8, wherein said support bar is configured to engage a plurality of loops formed by portions of the curtain extending from said first transverse edge of the curtain.

17. The roll-up door according to claim 3, wherein each of said curved support members has a concave support surface facing upwards and having a radius of curvature substantially equal to the radius of said cylindrical member.

18. The roll-up door according to claim 3, wherein the curved support members are fixed to said lower plate, preferably by screws.

19. The roll-up door according to claim 3, wherein a pair of opposite guide rails parallel to said uprights are associated with the portal structure, which guide rails have respective vertical grooves in which a pair of axial pins projecting from the opposite ends of the cylindrical member slidably engage.

20. The roll-up door according to claim 3, wherein said first transverse edge of the curtain is connected to the upper crosspiece of the portal structure by a horizontal support bar of the curtain and an angle bar connected to the upper crosspiece, and an adjustment device for the vertical position of the first transverse edge with respect to the upper crosspiece is provided.
